(19) United States
(12) Patent Application Publication
(10) Pub. No.: US 2002/0067130 A1
(43) Pub. Date: Jun. 6, 2002

(54) Flat-panel, large-area, dielectric barrier discharge-driven V(UV) light source

(76) Inventor: Zoran Falkenstein, Foothill Ranch, CA (US)

Correspondence Address: COUDERT BROTHERS, Suite 2300, 333 South Hope St.,, Los Angeles, CA, 90071, US

(21) Appl. No.: 09/730,185

(22) Filed: Dec. 5, 2000

(51) Int. Cl. H01J 11/00

(52) U.S. Cl. 313/607; 313/634; 313/636

(57) ABSTRACT

The present invention provides a DBD light sources having flat-plate, large-area panels and a system for designing such DBD light sources that withhold the mechanical stress caused during the lamp envelope cleaning (evacuation at elevated temperatures) and the pressure of final gas filling (if other than atmospheric). One or more embodiments of the present invention place mechanical stems inside of the lamp envelope which greatly reduce the mechanical stress at the sealing surface, as well as over the entire large area panel surface. In one embodiment, the stems are arranged so that they are equidistant. This design enables the mechanical stability of the lamp envelope during the cleaning (vacuum) process, as well as the filling of the lamp envelopes at other than atmospheric gas pressure.

### BACKGROUND OF THE INVENTION

1. Field of the Invention

The present invention relates to a flat-panel, large-area, dielectric barrier discharge-driven light source.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

Dielectric barrier discharge lamps (DBDs) can be realized when applying a high voltage across a gas gap, which is separated from metallic electrodes by at least one dielectric barrier. Dialectric barriers include, for instance, ceramic, glass, and quartz. FIG. 1A provides an example of a typical DBD.

DBDs

FIG. 1A is a side view of a coaxial DBD lamp. The lamp envelope 100 is a transparent vessel that is typically comprised of glass or quartz. In common arrangements, an inner electrode 110 is separated by a dielectric barrier 120 from plasma gases 130 enclosed within the envelope 100 and bounded on the outside by a second electrode 140 on the outer surface of the dielectric barrier.

FIG. 1B provides an end-on view of the same coaxial DBD lamp shown in FIG. 1A. In FIG. 1B, it can be seen more clearly that the inner electrode 110 and the outer electrode 140 are circular in shape, and that the plasma gases 130 are sealed between the two electrodes. The second electrode 140 may be a mesh which allows waves to be emitted from the lamp envelope. The discharge from a DBD is also widely known as “ozonizer discharge” as the utilization of DBDs is a mature technology to produce large amounts of ozone. Due to the nature of DBDs to generate non-thermal plasmas at atmospheric gas pressure, this type of discharge can also be used to efficiently produce excited diatomic molecules (excimers) when using rare gases, or mixtures of rare-gases and halogens as the discharge gas. The excimer will emit radiation in the deep ultra-violet ((V)UV), the ultra-violet (UV), or the visible spectral range when it decays. The radiation can be used for various photo-initiated or photo-sensitized applications for solids, liquids and gases.

Typical efficiencies of DBD-driven excimer (V)UV light sources depend on the electron densities and electron energy distribution function and can be “controlled” mainly by the applied voltage frequency and shape, gas pressure, gas composition and gas gap distance. With typical arrangements, such a DBD configuration only operates in a range of 1-20% efficiency. Using steep-rising voltage pulses, efficiencies in the range of 20-40% can be obtained. Still, what makes these light sources unique is that almost all of the radiation is emitted selectively. For photo-initiated or photo-sensitized processes, the emission can be considered quasi-monochromatic. Since many photo-physical and photo-chemical processes (e.g., UV curing and bonding, lacquer hardening, polymerization, material deposition, and UV oxidation) are initiated by a specific wavelength (ideally the excimer light source will emit close to those wavelengths), these light sources can be by far more effective than high-powered light sources that usually emit into a wide spectral range.

Manufacturing DBD-Driven Excimer (V)UV Sources

For the manufacturing of DBD-driven excimer (V)UV sources, it is critical to fill the rare gas (or rare gas/halogen mixture) at total pressures of 100 to 1500 Torr into clean lamp envelopes. If uncleaned lamp envelopes are used, low radiant efficiencies and poor lifetimes are obtained which will make DBD lamps not feasible for technical applications. The cleaning of the lamp bodies is generally performed by heating the lamp body to a temperature of about 800 degrees Celsius while evacuating the enclosed volume of the lamp envelope at less than 10⁻⁵ Torr. This treatment (as well as the gas fill pressure if not atmospheric) restricts the possible configurations of DBD lamps to tube-like shapes. Tube-like shapes can withhold the mechanical stress caused by evacuating the tubes in the cleaning process (or also when filling them to other than atmospheric gas pressure).

Illuminating Large-Area Surfaces

It is beneficial to illuminate large-area surfaces using (V)UV light sources, for instance in the manufacturing and cleaning of silicon wafers designed to be used in computer systems. Such silicon wafers must be completely free from chemical residues that are on the wafer after it is constructed. Illuminating the surface of the wafer with the (V)UV light source in an oxegyn-containing environment is a method by which this chemical residue is removed.

For the illumination of large-area surfaces such as silicon wafers, one scheme uses multiple tube shaped (V)UV light sources to cover the large area surface. This scheme is shown in FIG. 2A. There, multiple tube shaped (V)UV sources 200A-200E are placed near the flat processing surface 210 (e.g., the silicon wafer). This scheme, however, does not achieve a uniform radiant density, since the (V)UV source consists of many tube like shapes which emit radiation in varying directions. For that reason, this configuration restricts the ability to place the (V)UV sources 200A-200E radiating from the DBD very close to the large-area surface to be illuminated because the closer the non-uniform light source approaches, the more non-uniform the light source becomes. As the non-uniform light source is moved farther away from the surface to be illuminated, it becomes more uniform, however, there is a correspondingly less amount of light intensity on the surface, which is disadvantageous.

It is much more favorable to realize large-area, flat panel DBD sources, rather than tube-like sources. The flat panel design would allow a user to place the (V)UV source closer to the surface to be illuminated, which allows for higher radiant power densities with very high area uniformity. However, the mechanical stress caused by the vacuum on flat, large area plates during the cleaning process (and also the gas filling process) causes mechanical failure, which has prevented the ability to realize flat panel, large area DBD lamps with reasonable performance.

### SUMMARY OF THE INVENTION

The present invention relates to DBD light sources having flat-plate, large-area panels and a system for designing such DBD light sources that withhold the mechanical stress caused during the lamp envelope cleaning (evacuation at elevated temperatures) and the pressure of final gas filling (if other than atmospheric).

One or more embodiments of the present invention place mechanical stems inside of the lamp envelope which greatly reduce the mechanical stress at the sealing surface, as well as over the entire large area panel surface. In one embodiment, the stems are arranged so that they are equidistant. This design enables the mechanical stability of the lamp envelope during the cleaning (vacuum) process, as well as the filling of the lamp envelopes at other than atmospheric gas pressure.

The stems are non-conductive so that they do not short the cathode-sided with the anodesided dielectric. The stems may be attached to either one or both plates by a transfer-foil-technology, which uses very thin quartz plates as the bonding media between the stems and the plates. When heated to a sufficiently high temperature, the thin transfer quartz plates melt and bond to both the quartz stems and the silica plates.

In one embodiment, the DBD lamp is configured to radiate as an excimer (V)UV light source. In another embodiment, the large-area, flat-panels are circular, although they may be any suitable shape. In another embodiment, the stems are made of quartz, although the stems may be constructed from any suitable non-conductive material.

### BRIEF DESCRIPTION OF THE DRAWINGS

These and other features, aspects and advantages of the present invention will become better understood with regard to the following description, appended claims and accompanying drawings where:

FIG. 1A is a side view of a prior art coaxial DBD lamp.

FIG. 1B is an end view of the same prior art coaxial DBD lamp.

FIG. 2 is an example of a prior art illumination of a flat processing surface.

FIG. 3 is an example of an illumination of a flat processing surface according to the present invention.

FIG. 4A is a side view of a DBD light source having mechanical stems according to an embodiment of the present invention.

FIG. 4B is an end view of a DBD light source having mechanical stems according to an embodiment of the present invention.

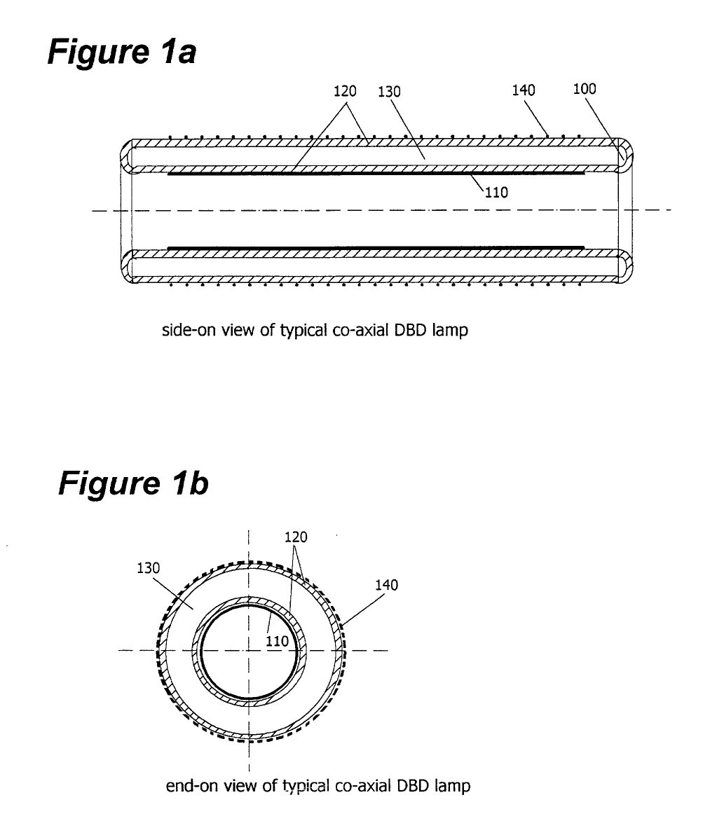

### DETAILED DESCRIPTION OF THE INVENTION

The invention relates to a flat-panel, large-area dielectric barrier discharge lamp. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

One or more embodiments of the present invention provide DBD light sources with flat-plate, large-area panels. Other embodiments of the present invention provide methods for manufacturing such DBD light sources that withhold the mechanical stress during the lamp envelope cleaning (evacuation at elevated temperatures) and final gas filling pressure (if other than atmospheric).

DBD Light Sources with Flat-Plate Large-Area Panels

According to one or more embodiments of the present invention, a DBD light source with large-area, flat panels is provided. FIG. 3 shows one embodiment of such a light source. There, a first electrode 300 and a second electrode 310 are parallel to one another and are separated by a gas gap 320, to form a DBD configuration. The second electrode 310 is a mesh which allows the light source to emit radiation toward a flat processing surface 330, such as a silicon wafer or other suitable flat processing surface.

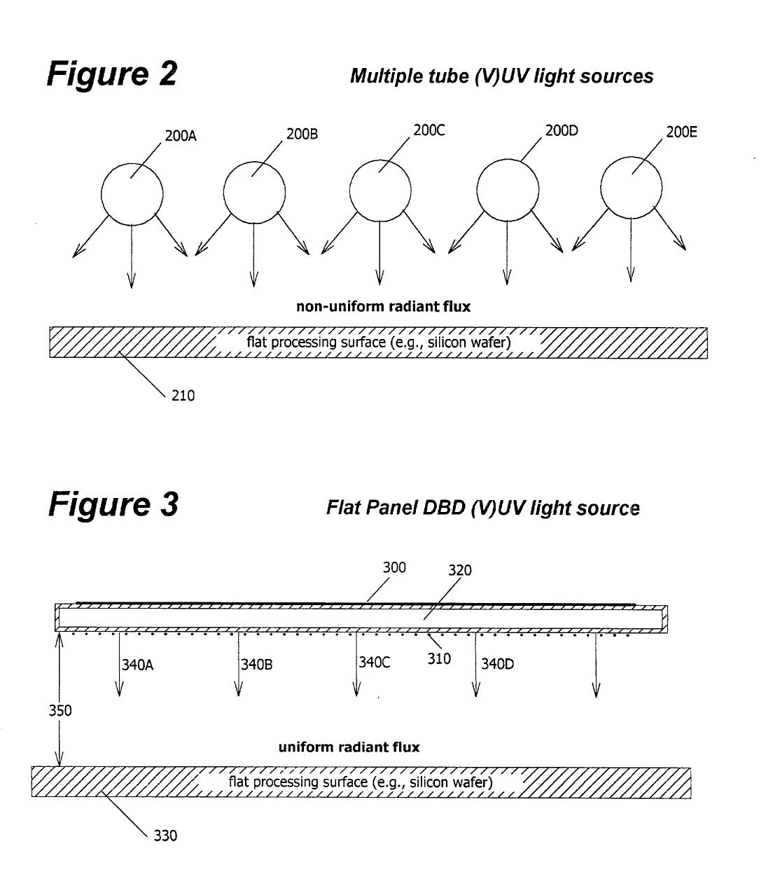

The shape of the light source of the present invention allows the emission of a uniform radiant flux, which is indicated bylines 340A-340D, as opposed to a non-uniform radiant emitted by prior art configurations such as the multiple tube-shaped light sources shown in FIG. 2. The uniform radiant flux 340A-340D results in a higher uniformity of light density on the flat processing surface 330 to be illuminated. In addition, the distance 350 between the light source and the flat processing surface 330 can be made very small, which allows for higher radiant power densities

Mechanical Stems

According to the present invention mechanical stems are placed inside of the lamp envelope. In one embodiment, the stems are equidistant. In another embodiment, the stems are made of quartz or another suitable non-conductive material. The stems reduce the mechanical stress at the sealing surface, as well as over the entire large-area panel surface. This design enables the mechanical stability of the lamp envelope during the cleaning process which is typically performed by heating the lamp body to a temperature of about 800 degrees Celsius while evacuating the enclosed volume of the lamp envelope at less than 10⁻⁵ Torr. In the past, the stress caused by the vacuum process has restricted DBD lamp configurations to tube like shapes. Additionally, the stem configuration allows for the filling of the lamp envelope at other than atmospheric gas pressure which in the past has also limited large-area DBD lamps to tube like shapes.

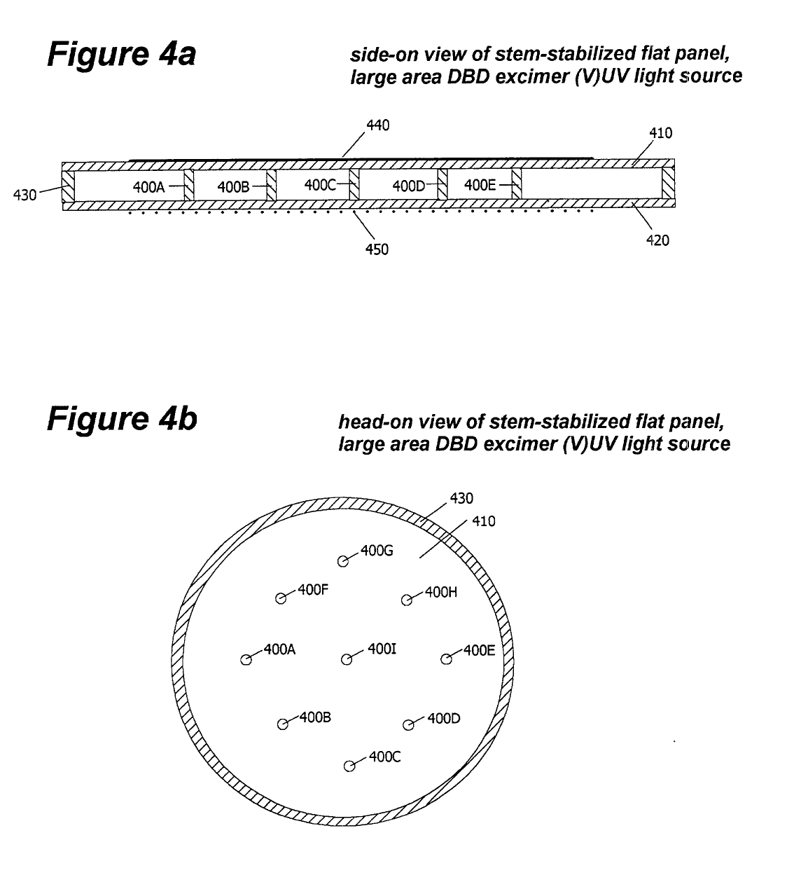

FIG. 4A shows a DBD lamp according to an embodiment of the present invention where mechanical stems are used. In FIG. 4A, stems 400A-400E, which maybe made of quartz or another suitable material, are placed between dielectric barriers 410 and 420, which maybe made of fused silica or another suitable material. A spacer 430 may also be used to further support dielectric barriers 410 and 420. Outside of dielectric barriers 410 and 420 are first and second electrodes 440 and 450 which complete the DBD configuration. The stems 400A-400E do not short the cathode-sided with the anode-sided dielectric because they are non-conductive.

FIG. 4B is an end-view of the same DBD light source shown in FIG. 4A. In FIG. 4B only one of the dielectric barriers 410 is visible. Outside of the dielectric barrier 410 is the spacer 430. From this view it can be seen that in this embodiment, the entire DBD light source configuration is circular, although other shapes are equally applicable in other embodiments. From this view it can further be seen that additional mechanical stems exist in the configuration which are labeled 400A-400I.

The stems 400A-400I may be attached to either one or both dielectric barriers 410 and 420 by transfer-foil-technology or other fusing techniques. Transfer-foil-technology uses very thin quartz plates as the bonding media between the stems 400A-400I and the barriers 410 and 420. For instance, in one scenario when heated to a sufficiently high temperature, the thin transfer quartz plates will melt and bond to both the quartz stems 400A-400I and the silica barriers 410 and 420.

Example Embodiments

One configuration of the present invention uses a lamp envelope that is 4 inches in diameter. The envelope holds three quartz stems, each being attached to both plates. The distance of the flat plates is about 1 mm. Other configurations of the present invention include excimer (V)UV sources that are 8 inches and 14 inches in diameter having varying numbers of mechanical stems. Another embodiment of the present invention uses a circular lamp envelope with a radius of 200 millimeters (mm). In this embodiment, the mechanical stems are placed equidistant from one another, approximately 50 mm apart, and each stem is 5 mm in length, meaning the gas gap within the lamp envelope is also 5 mm. Although the invention has been described with reference to specific configurations, however, one skilled in the art understands that the mechanical stems can be added to any practical DBD light source configuration that can withstand the lamp envelope cleaning or final gas filling process.

Industrial Applicability

Various (V)UV light sources are presently being applied in different surface treatment processes (such as surface cleaning, sterilization, material deposition, polymerization, hardening and curing). Most of the applied (V)UV light sources emit either in a broad spectral range, although it has proven that only certain wavelengths are responsible for the photochemical process. At the same time, the availability of possible wavelengths with traditional (V)UV light sources is very much limited. As a result, UV light sources which emit selectively in the spectral region where the photochemical process occurs, are highly desirable. At the same time, it is essential to have uniform radiant fluxes over the entire exposed area, as only this will guarantee equal performance characteristics of the surface.

Both criteria are given with the presented invention: In respect to wavelengths, DBD-driven (V)UV sources have already evolved and matured as alternative and superior sources for many industrial applications. In respect to surface uniformity, flat panel DBD lamps would be truly uniform.

Thus, a flat panel, large-area, dielectric barrier discharge-driven light source is described in conjunction with one or more specific embodiments. The invention is defined by the claims and their full scope of equivalents.

1. A dielectric barrier discharge-driven light source comprising:
a first and second dielectric barrier which enclose a gas;
a first and second electrode coupled to an outside portion of said first and second dielectric barriers; and
one or more stems coupled to an inside portion of said first and second dielectric barriers.

2. The light source of claim 1 wherein said first and second dielectric barriers have a flat-panel shape.

3. The light source of claim 2 where said flat panel shape is circular.

4. The light source of claim 1 wherein said stems are comprised of quartz.

5. The light source of claim 1 wherein said stems are equidistant.

6. The light source of claim 1 wherein said second electrode is a mesh.

7. The light source of claim 1 wherein said first and second dielectric barriers are comprised of silica.

8. The light source of claim 1 wherein said stems are coupled to said first and second dielectric barriers using transfer-foil-technology.

9. A method for manufacturing a dielectric barrier discharge-driven light source comprising:
coupling a first and second electrode to a corresponding outside portion of a first and second dielectric barrier;
coupling one or more stems to a corresponding inside portion of said first and second dielectric barriers;
cleaning a sealed area between said first and second dielectric barriers; and
adding a gas to said sealed area.

10. The method of claim 10 wherein said step of cleaning further comprises:
heating said dielectric barrier discharge-driven light source; and
exposing said dielectric barrier discharge-driven light source to a vacuum.

11. The method of claim 9 wherein said first and second dielectric barriers have a flat-panel shape.

12. The method of claim 11 where said flat-panel shape is circular.

13. The method of claim 9 wherein said stems are comprised of quartz.

14. The method of claim 9 wherein said stems are equidistant.

15. The method of claim 9 wherein said second electrode is a mesh.

16. The method of claim 9 wherein said first and second dielectric barriers are comprised of silica.

17. The method of claim 9 wherein said stems are coupled to said first and second dielectric barriers using transfer-foil-technology.
